(19) United States
(12) Patent Application Publication
(10) Pub. No.: US 2024/0164449 A1
(43) Pub. Date: May 23, 2024

(54) ELECTRONIC VAPORIZATION DEVICE, AND VAPORIZER AND VAPORIZATION ASSEMBLY THEREOF

(71) Applicant: SHENZHEN SMOORE TECHNOLOGY LIMITED, Shenzhen (CN)

(72) Inventors: Bo LI, Shenzhen (CN); Feng CHEN, Shenzhen (CN); Bing CHEN, Shenzhen (CN); Hongming ZHOU, Shenzhen (CN); Jicai LONG, Shenzhen (CN); Wangsheng LIU, Shenzhen (CN)

(21) Appl. No.: 18/431,021

(22) Filed: Feb. 2, 2024

Related U.S. Application Data
(63) Continuation of application No. PCT/CN2022/106541, filed on Jul. 19, 2022.

(30) Foreign Application Priority Data
Aug. 13, 2021 (CN) 202121904618.2

(51) Int. Cl. A24F 40/46; A24F 40/10; H05B 3/26

(52) U.S. Cl. CPC A24F 40/46; A24F 40/10; H05B 3/265; H05B 2203/013; H05B 2203/016; H05B 2203/021

(57) ABSTRACT

A vaporization assembly includes: a porous substrate; and a heating element. The porous substrate has a vaporization surface, and the heating element is arranged on the vaporization surface. The porous substrate includes a fence structure, and the fence structure surrounds the vaporization surface, defining an accommodating groove. In an embodiment, the fence structure is arranged on a peripheral edge of a vaporization end of the porous substrate, and an area of the vaporization end within the fence structure forms the vaporization surface.

### CROSS-REFERENCE TO PRIOR APPLICATION

This application is a continuation of International Patent Application No. PCT/CN2022/106541, filed on Jul. 19, 2022, which claims priority to Chinese Patent Application No. 202121904618.2, filed on Aug. 13, 2021. The entire disclosure of both applications is hereby incorporated by reference herein.

### FIELD

The present invention relates to the field of vaporization, and more specifically, to an electronic vaporization device, and a vaporizer and a vaporization assembly thereof.

### BACKGROUND

As a form of a heating film structure, a porous planar heating film has advantages such as uniform heat distribution, stable vaporization temperature, and high vaporization efficiency. In recent years, the porous planar heating film has been used on a ceramic heating element of an electronic vaporizer. However, the porous planar heating film currently used on the heating element implements supply of a liquid vaporization medium or an oil vaporization medium relying only on a porous structure of a carrier substrate and micropores on the heating film, leading to excessive local temperature due to insufficient or uneven supply of liquid/oil, causing a risk of failure and low reliability.

### SUMMARY

In an embodiment, the present invention provides a vaporization assembly, comprising: a porous substrate; and a heating element, wherein the porous substrate comprises a vaporization surface, and the heating element is arranged on the vaporization surface, and wherein the porous substrate comprises a fence structure, and the fence structure surrounds the vaporization surface, defining an accommodating groove.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic top structural view of a vaporization assembly according to a first embodiment of the present invention;

FIG. 2 is a schematic cross-sectional structural view of the vaporization assembly shown in FIG. 1;

FIG. 3 is a schematic top structural view of a vaporization assembly according to a second embodiment of the present invention;

FIG. 4 is a schematic cross-sectional structural view of the vaporization assembly shown in FIG. 3; and

FIG. 5 is a schematic three-dimensional structural view of an electronic vaporization device according to some embodiments of the present invention.

### DETAILED DESCRIPTION

In an embodiment, the present invention provides an electronic vaporization device, and a vaporizer and a vaporization assembly thereof for the foregoing defects in the related art.

In an embodiment, the present invention provides constructing a vaporization assembly, including a porous substrate and a heating element. The porous substrate includes a vaporization surface, and the heating element is arranged on the vaporization surface; and the porous substrate further includes a fence structure, and the fence structure surrounds the vaporization surface, defining an accommodating groove.

Preferably, the fence structure is arranged on the peripheral edge of a vaporization end of the porous substrate, and the area of the vaporization end within the fence structure forms the vaporization surface.

Preferably, the fence structure is arranged on the vaporization end of the porous substrate, a gap is provided between the outer wall surface of the fence structure and the peripheral edge of the vaporization end of the porous substrate, and the area of the vaporization end within the fence structure forms the vaporization surface.

Preferably, the fence structure and the porous substrate are integrally formed, and are made of the same material.

Preferably, the vaporization surface is a flat surface.

Preferably, the heating element is a planar porous heating film laid flat on the vaporization surface.

Preferably, the height of the fence structure is at least 10 μm to 20 μm greater than the thickness of the heating element.

Preferably, the thickness of the heating element ranges from 10 μm to 80 μm.

Preferably, the pore size of the pore on the porous heating film ranges from 10 μm to 200 μm.

Preferably, the porosity of the porous heating film ranges from 10% to 70%.

Preferably, the vaporization assembly further includes two electrode portions connected to two ends of the heating elements.

Preferably, the electrode portion is arranged within the fence structure.

Preferably, the thickness of the electrode portion is greater than the height of the fence structure.

Preferably, a connection section configured to reduce a temperature gradient at a joint is arranged between the heating element and the electrode portion.

Preferably, the connection section includes an inclined surface with smooth transition.

Preferably, the porous substrate is a porous ceramic substrate.

The present invention further constructs a vaporizer, including the vaporization assembly according to any one of the above.

The present invention further constructs an electronic vaporization device, including the vaporizer and a power supply electrically connected to the vaporizer.

Beneficial Effects:

By implementing the electronic vaporization device, and the vaporizer and the vaporization assembly thereof in the present invention, the following beneficial effects can be achieved:

A liquid aerosol-generation substrate is filled in the accommodating groove, providing sufficient and uniform liquid aerosol-generation substrate for the heating element, which effectively prevents excessive local temperature of the heating element, improving reliability of the heating element.

In the accompanying drawings: 1. porous substrate, 11. vaporization end, 111. vaporization surface, 12. liquid guide end, 121. liquid guide surface, 2. heating element, 21. connection section, 211. inclined surface, 3. fence structure, 4. electrode portion, 5. accommodating groove, 10. vaporizer, 101. housing, 20. power supply, and 201. bracket.

To make the objectives, technical solutions, and advantages of the present invention more comprehensible, the present invention is further described in detail below with reference to embodiments and the accompanying drawings. Illustrative implementations and descriptions thereof in the present invention are merely used for illustrating the present invention, and are not intended to limit the present invention.

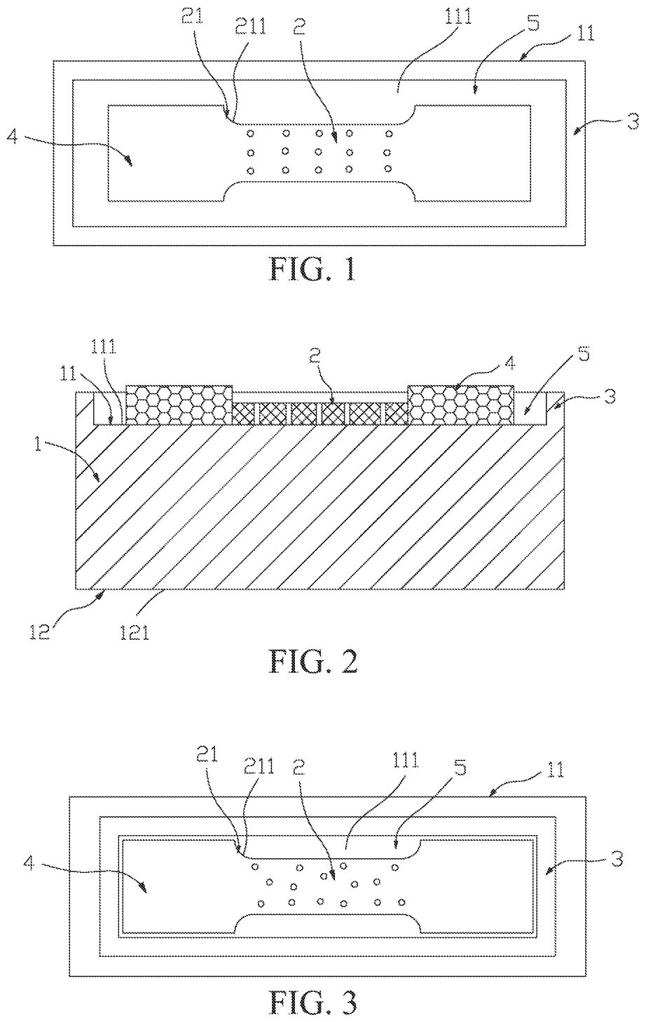

FIG. 1 and FIG. 2 show a vaporization assembly according to a first embodiment of the present invention. The vaporization assembly may include a porous substrate 1 configured to absorb a liquid aerosol-generation substrate from a liquid storage cavity of a vaporizer 10, and a heating element 2 arranged on the porous substrate 1 and configured to heat and vaporize the liquid aerosol-generation substrate absorbed in the porous substrate 1.

The porous substrate 1 includes a liquid guide end 12 and a vaporization end 11 arranged opposite to the liquid guide end 12. A liquid guide surface 121 is arranged on the liquid guide end 12, and the liquid guide surface 121 is configured for liquid communication with the liquid storage cavity. A vaporization surface 111 configured to mount the heating element 2 is arranged on the vaporization end 11. In this embodiment, the porous substrate 1 is cuboid. The end surface of the liquid guide end 12 of the porous substrate 1 and the end surface of the vaporization end 11 are rectangular, and the end surface of the liquid guide end 12 is parallel to the end surface of the vaporization end 11. In another embodiment, the cross section of the porous substrate 1 may alternatively be square, rhombic, trapezoidal, circular, oval, or of another shape.

The vaporization assembly further includes a fence structure 3. The fence structure 3 is arranged on the end surface of the vaporization end 11, and surrounds the vaporization surface 111, defining an accommodating groove 5. In this embodiment, the fence structure 3 is arranged on the peripheral edge of the end surface of the vaporization end 11, the area of the vaporization end 11 within the fence structure 3 forms the vaporization surface 111, and the fence structure 3 is arranged in a closed manner, so that the fence structure 3 and the vaporization surface 111 together define the accommodating groove 5. It may be understood that due to the arrangement of the fence structure 3, the accommodating groove 5 with a large volume is formed, so that more liquid aerosol-generation substrates can be accommodated.

As shown in FIG. 2, the fence structure 3 is perpendicularly arranged on the end surface of the vaporization end 11. The outer wall surface of the fence structure 3 is flush with the peripheral edge of the end surface of the vaporization end 11. The upper end surface of the fence structure 3 is arranged flush and is parallel to the end surface of the vaporization end 11, to ensure that the liquid aerosol-generation substrate filled everywhere in the accommodating groove 5 is relatively uniform. The fence structure 3 may be formed by extending outward from the end surface of the vaporization end 11. In this embodiment, the fence structure 3 may be integrally formed on the end surface of the vaporization end 11, and the fence structure 3 and the vaporization end 11 are made of the same material.

The vaporization surface 111 is arranged on the end surface of the vaporization end 11. The vaporization surface 111 is a flat surface for the heating element 2 to be arranged thereon. In this embodiment, the end surface of the vaporization end 11 may also be a flat surface, so that the vaporization surface 111 with a flat surface is formed on the end surface of the vaporization end 11. The end surface of the liquid guide end 12 is the liquid guide surface 121. In this embodiment, the porous substrate 1 has a capillary structure, and thus has a capillary force. The heating element 2 is of a porous structure.

It may be understood that when an external circuit is started to perform normal vaporization, the porous substrate 1 absorbs the liquid aerosol-generation substrate on the liquid guide surface 121 of the liquid guide end 12 to the vaporization surface 111 of the vaporization end 11 through the capillary force, and provides the liquid aerosol-generation substrate for the heating element 2. The heating element 2 heats and vaporizes the liquid aerosol-generation substrate flowing into the porous structure of the heating element 2. In addition, the arrangement of the fence structure 3 enables the liquid aerosol-generation substrate on the vaporization surface 111 of the vaporization end 11 to be filled in the accommodating groove 5. This ensures sufficient supply and uniform supply of the liquid aerosol-generation substrate during vaporization, thereby effectively preventing excessive local temperature of the heating element 2.

The porous substrate 1 may be a porous ceramic substrate. In another embodiment, the porous substrate 1 may alternatively be a hard capillary structure such as glass ceramic or glass. The arrangement of the capillary structure of the porous substrate 1 ensures absorption of the liquid aerosol-generation substrate. The heating element 2 may be a planar porous heating film laid flat on the vaporization surface 111, and may be formed on the porous substrate 1 through screen printing, vacuum coating, or another manner. It may be understood that the planar porous heating film has characteristics such as uniform temperature field distribution and high energy utilization rate, facilitating sufficient vaporization. In another embodiment, the heating element 2 may alternatively be a heating component such as a heating sheet with a porous structure. Due to the porous structure of the heating element 2, the liquid aerosol-generation substrate may be heated and vaporized in the porous structure to take away heat, preventing the heating element 2 from failing due to excessive high temperature caused by sufficient liquid aerosol-generation substrate in the accommodating groove 5.

The thickness of the planar porous heating film may range from 10 μm to 80 μm, the pore size of the pore on the porous heating film may range from 10 μm to 200 μm, and the porosity of the porous heating film may range from 10% to 70%. In this embodiment, the width of the planar porous heating film may range from 0.5 mm to 3.0 mm. In another embodiment, the length and the width of the planar porous heating film may be selectively set according to the size of the vaporization surface 111.

As shown in FIG. 2, the height of the fence structure 3 is greater than the thickness of the porous heating film. In this embodiment, the height of the fence structure 3 is at least 10 μm to 20 μm greater than the thickness of the porous heating film. Therefore, when filled in the accommodating groove 5, the liquid aerosol-generation substrate may submerge the porous heating film, so that the surface layer of the porous heating film is uniformly covered with an oil film formed by the liquid aerosol-generation substrate. It may be understood that the porous substrate 1 absorbs the liquid aerosol-generation substrate through the capillary force and supplies the liquid aerosol-generation substrate to the heating element 2, covering the bottom layer of the heating element 2. Through the cofferdam arrangement, the surface layer and the bottom layer of the porous heating film are both surrounded and covered by the liquid aerosol-generation substrate, which ensures sufficient supply of the liquid aerosol-generation substrate during vaporization.

The fence structure 3 may have a capillary structure, and the liquid aerosol-generation substrate is gradually filled in the whole accommodating groove 5 along the fence structure 3 under a capillary force of the fence structure 3. In this embodiment, the fence structure 3 may be made of porous ceramic. In another embodiment, the fence structure 3 may be a hard capillary structure such as glass ceramic or glass.

The vaporization assembly further includes electrode portions 4 connected to two ends of the porous heating film. The electrode portion 4 is arranged in the accommodating groove 5 and surrounded by the fence structure 3, and the thickness of the electrode portion 4 is greater than the height of the fence structure 3. The electrode portion 4 is electrically connected to the power supply 20, to supply power to the porous heating film. The porous heating film heats and vaporizes the liquid aerosol-generation substrate when the electrode portion 4 is energized. The two electrode portions 4 may be respectively located on two ends of the porous heating film in the length direction. The porous heating film may be arranged in a straight shape, an S shape, or another shape. The electrode portion 4 may be a bonding pad.

The porous heating film and the electrode portion 4 may both be cuboid, and the width of the electrode portion 4 is greater than the width of the porous heating film. The porous heating film and the electrode portion 4 are arranged in a stepped form, and a connection section 21 configured to reduce a temperature gradient at a joint is arranged between the porous heating film and the electrode portion 4. It may be understood that a slow cooling trend is presented from the center of the porous heating film toward the electrode portion 4, and the arrangement of the connection section 21 can improve resistance to cold and hot shocks at the joint.

The cross section of the connection section 21 is substantially a triangle. The connection section 21 is arranged on two sides of the porous heating film in the length direction, and connects the porous heating film and the electrode portion 4. An inclined surface 211 with smooth transition is arranged on the connection section 21, and the inclined surface 211 is located on a side facing away from the porous heating film, to reduce a gradient between the porous heating film and the electrode portion 4. In this embodiment, the connection section 21 and the porous heating film are integrally formed, and are made of the same material.

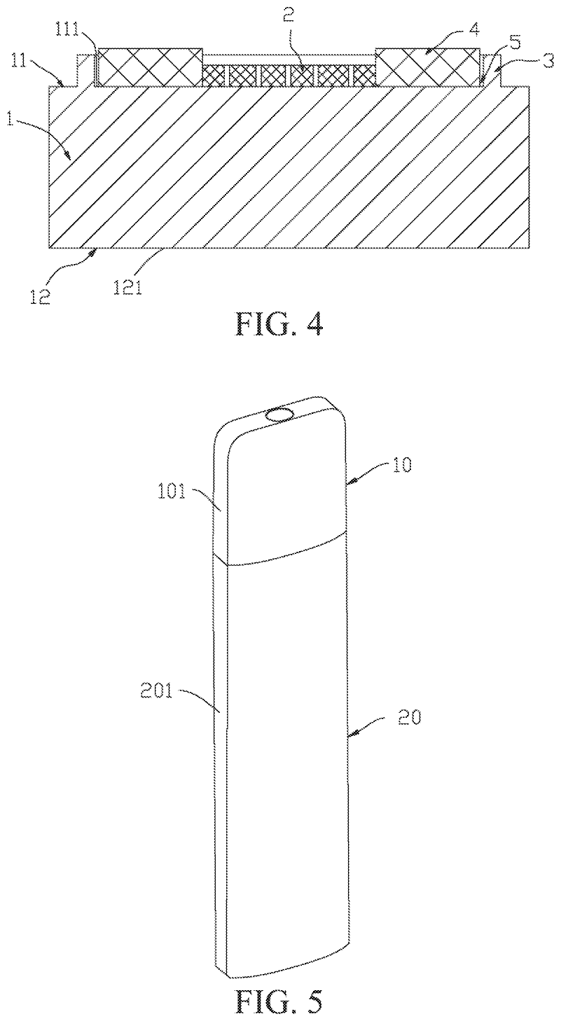

FIG. 3 and FIG. 4 show a vaporization assembly according to a second embodiment of the present invention. A difference between the vaporization assembly and the vaporization assembly in the first embodiment lies in different arrangement positions of the fence structure 3. As shown in FIG. 3 and FIG. 4, in this embodiment, the fence structure 3 is arranged on the end surface of the vaporization end 11 of the porous substrate 1, and a gap is provided between the outer wall surface of the fence structure 3 and the peripheral edge of the end surface of the vaporization end 11. The area of the vaporization end 11 within the fence structure 3 forms the vaporization surface 111, so that the fence structure 3 and the vaporization surface 111 together define an accommodating groove 5. It may be understood that the fence structure 3 with such arrangement may tightly surround the periphery of the heating element 2, so that the liquid aerosol-generation substrate filled in the accommodating groove 5 can be sufficiently supplied to the heating element 2.

FIG. 5 shows an electronic vaporization device according to some embodiments of the present invention. As shown in FIG. 5, the electronic vaporization device may be substantially in a shape of a square column, and includes a vaporizer 10 and a power supply 20 electrically connected to the vaporizer 10. The vaporizer 10 may include a housing 101 and a vaporization assembly arranged in the housing 101. A liquid storage cavity configured to store a liquid aerosol-generation substrate is formed in the housing 101. A liquid guide surface 121 on a liquid guide end 12 of a porous substrate 1 is in communication with the liquid storage cavity. A vaporization surface 111 on a vaporization end 11 of the porous substrate 1 faces away from the liquid storage cavity, and a vaporization cavity is provided on a corresponding side of the vaporization surface 111 in the vaporizer 10.

The power supply 20 may include a bracket 201, and a battery, a circuit board, and an airflow sensor that are arranged in the bracket 201. The vaporizer 10 may be connected to the power supply 20 in a detachable manner such as magnetic attraction or thread-connection. The positive electrode and the negative electrode of the battery are electrically connected to two electrode portions 4 respectively, to supply power to the heating element 2.

It may be understood that the liquid storage cavity may store a liquid aerosol-generation substrate. The porous substrate 1 absorbs the liquid aerosol-generation substrate onto the vaporization surface 111 through a capillary force and fills the liquid aerosol-generation substrate in an accommodating groove 5. When energized, the heating element 2 heats and vaporizes the liquid aerosol-generation substrate supplied by the porous substrate 1 and filled in the accommodating groove 5, to generate an aerosol substrate and fill the aerosol substrate in the vaporization cavity for inhalation. It may be understood that the liquid aerosol-generation substrate obtained by the heating element 2 from the porous substrate 1 and the accommodating groove 5 is sufficient and uniform, and the vaporization effect is good, thereby improving user experience.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A vaporization assembly, comprising:
a porous substrate; and
a heating element,
wherein the porous substrate comprises a vaporization surface, and the heating element is arranged on the vaporization surface, and
wherein the porous substrate comprises a fence structure, and the fence structure surrounds the vaporization surface, defining an accommodating groove.

2. The vaporization assembly of claim 1, wherein the fence structure is arranged on a peripheral edge of a vaporization end of the porous substrate, and an area of the vaporization end within the fence structure forms the vaporization surface.

3. The vaporization assembly of claim 1, wherein the fence structure is arranged on a vaporization end of the porous substrate, a gap is provided between an outer wall surface of the fence structure and a peripheral edge of the vaporization end of the porous substrate, and an area of the vaporization end within the fence structure forms the vaporization surface.

4. The vaporization assembly of claim 1, wherein the fence structure and the porous substrate are integrally formed, and comprise a same material.

5. The vaporization assembly of claim 1, wherein the vaporization surface comprises a flat surface.

6. The vaporization assembly of claim 1, wherein the heating element comprises a planar porous heating film laid flat on the vaporization surface.

7. The vaporization assembly of claim 6, wherein a height of the fence structure is at least 10 μm to 20 μm greater than a thickness of the heating element.

8. The vaporization assembly of claim 6, wherein a thickness of the heating element ranges from 10 μm to 80 μm.

9. The vaporization assembly of claim 6, wherein a pore size of a pore on the porous heating film ranges from 10 μm to 200 μm.

10. The vaporization assembly of claim 6, wherein a porosity of the porous heating film ranges from 10% to 70%.

11. The vaporization assembly of claim 1, further comprising:
two electrode portions connected to two ends of the heating element.

12. The vaporization assembly of claim 11, wherein one electrode portion of the two electrode portions is arranged within the fence structure.

13. The vaporization assembly of claim 12, wherein a thickness of the one electrode portion is greater than a height of the fence structure.

14. The vaporization assembly of claim 11, wherein a connection section configured to reduce a temperature gradient at a joint is arranged between the heating element and one electrode portion of the two electrode portions.

15. The vaporization assembly of claim 14, wherein the connection section comprises an inclined surface with smooth transition.

16. The vaporization assembly of claim 1, wherein the porous substrate comprises a porous ceramic substrate.

17. A vaporizer, comprising:
the vaporization assembly of claim 1.

18. An electronic vaporization device, comprising:
the vaporizer of claim 17; and
a power supply electrically connected to the vaporizer.
